(19) United States
(12) Patent Application Publication
(10) Pub. No.: US 2006/0161755 A1
(43) Pub. Date: Jul. 20, 2006

(54) Systems and methods for evaluation and re-allocation of local memory space

(75) Inventors: Takayuki Uchikawa, Austin, TX (US); Yoshiyuki Hamaoka, Austin, TX (US); Kazuko Ishibashi, Austin, TX (US)

Correspondence Address: LAW OFFICES OF MARK L. BERRIER, 3811 BEE CAVES ROAD, SUITE 204, AUSTIN, TX, 78746, US

(73) Assignee: Toshiba America Electronic Components

(21) Appl. No.: 11/039,431

(22) Filed: Jan. 20, 2005

(51) Int. Cl. G06F 12/00

(52) U.S. Cl. 711/170

(57) ABSTRACT

Systems and methods for improving the efficiency of memory usage in a computing system by periodically evaluating the usage of local memory by each of the buffers implemented in the memory and changing the allocation of the local memory to the different buffers if necessary to improve the performance of the system. In one embodiment, after an initial allocation of local memory space to each buffer, the use of the local memory space by the buffers is evaluated using a function based upon static and dynamic factors. The allocation of local memory space to each buffer is based upon the results of the function. The evaluation and re-allocation is transparent to the processors using the buffers, and may be performed in response to an interrupt or expiration of a timer.

### BACKGROUND

1. Field of the Invention

The invention relates and generally to multiprocessor computer systems, and more particularly to systems and methods for improving allocation of local memory space among multiple processors to improve the efficiency of memory usage and to reduce the amount of resources that are required to communicate data between local memory and system memory.

2. Related Art

As the complexity of data processing applications increases, there is a need for increased processing power. This need for increased processing power may be met in a number of ways. For example, rather than providing a single processor to execute an application, multiple processors may be used. It may be convenient to use multiple processors to execute applications such as multimedia applications because of the many different types of tasks that may need to be performed and the ability to configure the different processors so that they are optimized to perform these different tasks.

One type of multiprocessor system is implemented on a single chip (integrated circuit.) One conventional single-chip multiprocessor has a certain amount of memory on the chip along with the multiple processor cores. Portions of this memory are allocated to the different processors, and are used by the processors as working memory or “scratch pad” memory. This working memory is used by each of the processors to store and retrieve data used in the execution of instructions by the processors. Since the working memory is on the chip, it can be accessed more quickly than if it were not implemented on the chip.

While implementation of memory on the chip improves the access speed of the memory, it typically is not possible to provide a great deal of memory on the chip. Because the amount of space on the chip is limited, the size of the working memory is also limited. As a result, the working memory is typically used only as a temporary data storage. Data that needs to be stored for a longer period may be stored in a memory that is off-chip, such as a system memory or an external I/O memory. The working memory is then used as a buffer for data that is being transferred between the processors and the main memory.

In one multiprocessor system, a single memory space is provided on the chip with the processors. Different segments of this memory space are used to store different types of information. One segment (the code segment) stores the application code that is executed by the processors. Another segment (the data and/or BSS segment) stores data that is used by the application. A third segment (the stack) is used to store information for execution of the application, such as the variables and local data which are used by the different subroutines that are called in the application. A fourth segment (the heap) includes the remaining memory space and is used in this system as the working memory for the processors.

Conventionally, space in the heap is allocated to each of the processors for use as the working memory of the processor. The working memory for each processor is statically allocated before execution of the application begins. Typically, the amount of space to be allocated to each processor is estimated by a system designer based upon the anticipated needs of the processor. Once the memory space is allocated to the processor, this allocation is not changed.

The static allocation of space for the working memories of the processors may result in several problems. One of these problems is that the potential over-allocation of space to particular processor. If too much space is allocated, the allocation reduces the amount of space that can be used for the stack and thereby degrades the performance of the processors. On the other hand, if too little space is allocated, the under-allocation necessitates additional memory transfer operations to move data between the working memory and the system (or other offer-chip) memory. Again, performance of the processor is reduced.

It would therefore be desirable to provide systems and methods for improving the performance of a multiprocessor system by dynamically optimizing the allocation of on-chip memory space in order to reduce the under- and over-allocation of memory that is typical of static memory allocation schemes.

### SUMMARY OF THE INVENTION

One or more of the problems outlined above may be solved by the various embodiments of the invention. Broadly speaking, the invention includes systems and methods for improving the efficiency of memory usage in a multiprocessor computing system by evaluating the usage of local memory by each of the processors in the system and changing the allocation of the local memory to the different processors if necessary to improve the performance of the system.

One embodiment comprises a method including making an initial allocation of local memory space to a plurality of processors, performing an evaluation of use of the local memory space by the processors, and re-allocating the local memory space to the processors based upon the evaluation. In one embodiment, the processors and the local memory are constructed on a single chip. The local memory space allocated to each of the processors is used by the corresponding processor as a buffer that is configured to temporarily store data transferred to/from an off-chip system memory so that the data can be locally accessed by the processors. Evaluation of use of the local memory space may comprise evaluating a function based upon one or more static and dynamic factors, such as data type, data size, frequency of data accesses, number of data transfers between the local memory and a system memory, and so on. The function may be used to evaluate the “importance” of the buffer for each processor, and the allocation of local memory space to each processor's buffer may be based upon (e.g., allocated in proportion to) the corresponding importance value. In one embodiment, the evaluation and re-allocation of local memory space is transparent to the processors, and may be performed in response to an interrupt or expiration of a timer. The evaluation and re-allocation functions may be implemented in one of the processors in a multiprocessor system, or in a memory management unit (MMU) that is separate from the processors.

An alternative embodiment comprises a software program product that includes a computer-readable storage medium containing program instructions configured to cause a computer to perform a method generally as described above.

Another alternative embodiment comprises a system including a plurality of processors, a local memory coupled to the processors, and a local memory manager coupled to the local memory. The local memory manager is configured to periodically evaluate of use of the local memory by the processors and to re-allocate the local memory to the processors based upon the evaluation. In one embodiment, the processors and the local memory are constructed on a single chip, and the local memory allocated to each processor is used by the processor as a buffer to temporarily store data from an off-chip system memory so that the data can be locally accessed by the processor. The local memory manager may evaluate the local memory usage using a function that is based upon both static and dynamic factors. The local memory manager may use the result of the function as the basis for allocating local memory space to each processor's buffer (e.g., allocating space in proportion to function result.) The local memory manager operates transparently to the processors and may initiate the evaluation and re-allocation functions in response to an interrupt or expiration of a timer. The local memory manager may be implemented in software or hardware. The memory manager may be implemented in one of the processors in a multiprocessor system, or in a memory management unit (MMU) that is separate from the processors.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the structure of a multiprocessor computing system in accordance with one embodiment.

FIG. 2 is a diagram illustrating the use of the local memory as working space for each of a plurality of processors in accordance with one embodiment.

FIG. 3 is a diagram illustrating the organization of local memory for a processor and the correspondence of the processor's buffers to the system memory in accordance with one embodiment.

FIG. 4 is a diagram illustrating the re-allocation of local memory space to buffers associated with different processors in accordance with one embodiment.

FIG. 5 is a table illustrating the manner in which “importance” values for buffers corresponding to multiple processors are stored in accordance with one embodiment.

FIG. 6 is a flow diagram illustrating a method for evaluating local memory usage and re-allocating local memory space to different processors' buffers in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention includes systems and methods for improving the efficiency of memory usage in a multiprocessor computing system by evaluating the usage of local memory by each of the processors in the system and changing the allocation of the local memory to the different processors if necessary to improve the performance of the system.

One embodiment comprises a multiprocessor computing system in which multiple processors are constructed on the same integrated circuit chip as a local memory. The local memory has one portion that stores software code (program instructions) and global data and variables. Another portion of the local memory stores stack data (e.g., data that is used by the processors to keep track of the respective variables and other local information which they use in operation.) The remaining portion of the local memory is referred to as the “heap.” The heap is allocated among the processors to be used as “working memory,” or “scratchpad memory.” Data that is needed by a particular processor is moved from a larger, system memory that is not on the same chip as the processors to the working memory of the processor, where it is used by the processor. The storage of the data in the local memory increases the speed with which the data can be accessed by the processor.

Instead of statically allocating the heap of the local memory to the different processors, the allocation of the local memory space is changed from time to time. The re-allocation of the memory is based upon an evaluation of the different buffers' use of the corresponding memory space that is currently allocated to each of the buffers. If the local memory allocated to a particular buffer is being under-utilized, the allocation for this buffer is reduced, so that the unused memory space can be used for a different purpose. If the local memory allocated to a particular processor is not sufficient for the needs of the processor, the allocation for this processor is increased. This may, for example, reduce the amount of resources that are required to move data from the system memory to the allocated local memory space, or vice versa.

The re-allocation of the local memory space to the different processors is performed in one embodiment by a memory management unit (MMU) that makes this and corresponding functions transparent to the processors. The processors simply access the data in the normal manner, while the MMU manages the allocation of the local memory space. The MMU may base its evaluation and re-allocation of the local memory space upon a number of factors, some of which may be static, and others at which may dynamically change. These factors may, for example, include the frequency of data accesses, the data types being accessed, the importance of a particular processor's functions, realtime constraints and so on.

This embodiment, and other, alternative embodiments will be described in more detail below. It may be helpful to an understanding of these embodiments to first describe an exemplary system in which they can be implemented.

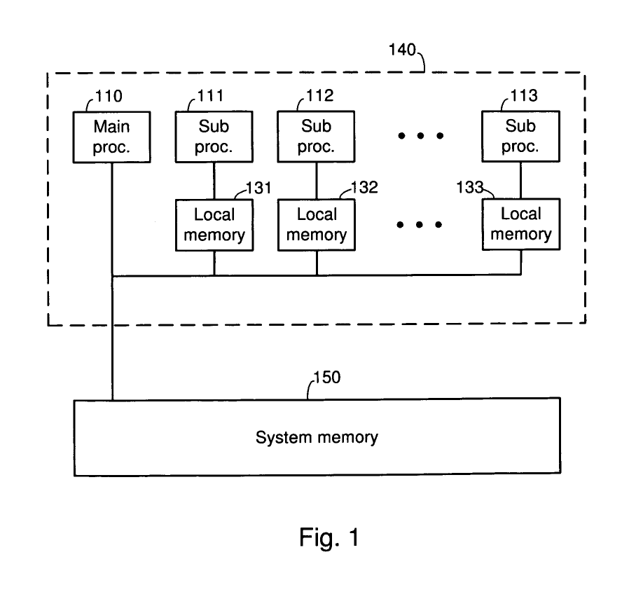

Referring to FIG. 1, a functional block diagram illustrating the structure of a multiprocessor computing system in accordance with one embodiment is shown. In this embodiment, the system includes multiple processors 110-113. Processor 110 is a main processor, while processors 111-113 are sub-processors. Each of sub-processors 111-113 is coupled to a corresponding local memory 131-133. Main processor 110 is coupled directly to a system memory 150, while sub-processors 111-113 are coupled to system memory 150 through corresponding local memories 131-133.

It should be noted that the structure depicted in FIG. 1 does not include all of the components that may be included in the computing system. This figure is provided merely to illustrate the particular components of the system that are relevant to the present discussion. It should also be noted that the illustrated structure may not be applicable to some alternative embodiments.

Referring again to FIG. 1, processors 110-113 and local memories 131-133 are all constructed on a single integrated circuit chip. Because of the physical proximity of on-chip components 140, these components can communicate data and interact with each other more quickly than they can communicate more interact with off-chip components of the system. Thus, in operation, sub-processors 111-113 typically do not operate directly on data that resides in system memory 150, but instead of operate on copies of the data that are stored in local memories 131-133. As data is needed by each of sub-processors 111-113, the data is moved (copied) from system memory 150 to local memories 131-133. It may also be necessary to move data that is not currently being used by the processors out of local memories 131-133 so that this memory space can be used to store currently needed data. The movement of data between local memories 131-133 and system memory 150 can, in one embodiment, be performed by a direct memory access (DMA) engine that is coupled to these memories.

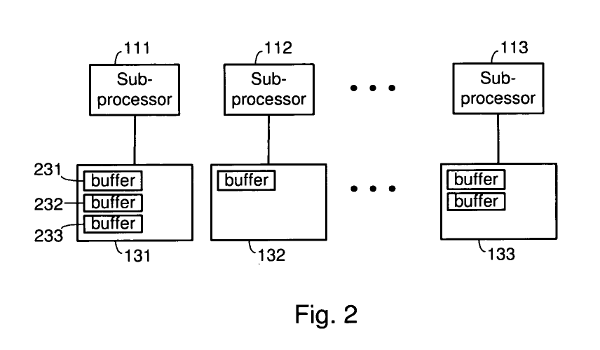

Referring to FIG. 2, a diagram illustrating the use of the local memory as working space for each of the processors in accordance with one embodiment is shown. Each of processors 111-113 may use one or more buffers within the corresponding local memory 131-133. Each of the buffers (e.g., 231-233) is simply a portion of the local memory space that is allocated for a particular use. The processor uses the buffers in its local memory as a working memory, or scratchpad memory. This working memory stores data that is currently being used by the processor to perform its functions. For example, if a particular one of the processors is configured to transform data values in one domain to another domain, the initial and transformed values may be stored in the working memory. As noted above, this use of the local memory to store the data that is currently being used by the processors enables the processors to access the data with greater speed than if the data were stored in an off-chip memory.

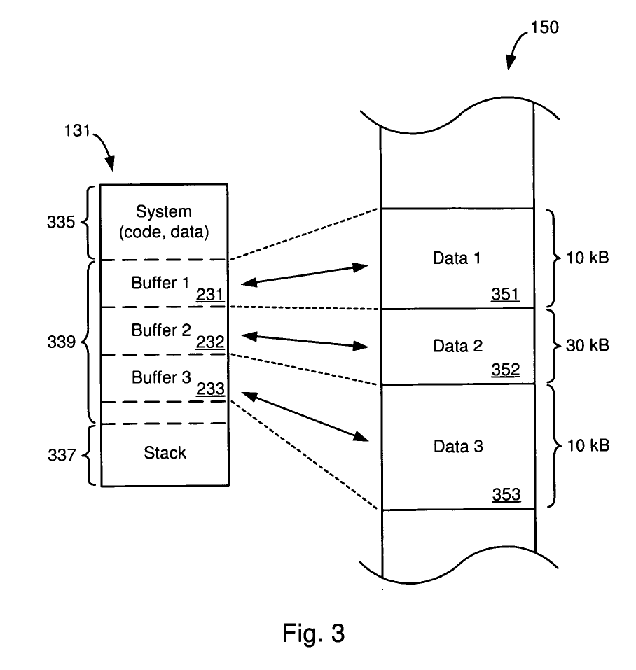

Referring to FIG. 3, a diagram illustrating the organization of the local memory for one of the processors and the correspondence of the processors' buffers to the system memory in accordance with one embodiment is shown. In this figure, local memory 131 includes three portions or segments. The first segment 335 is referred to as the system or code segment. This segment of local memory 131 is used to store software code (program instructions) that is executed by the processors. Code segment 335 may also be used to store global data that is used by the processors.

The second segment 337 of local memory 131 is referred to as the stack. Stack 337 is used to store data relating, for example, to the calling of subroutines within the executing application. For instance, when an application begins executing a subroutine that uses the same variables as a calling routine, the variables corresponding to the calling routine are stored in stack 337 while the subroutine is being executed. When the subroutine is completed and control returns to the calling routine, the variables are retrieved from stack 337 for use in execution of the calling routine.

The third segment 339 of local memory 131 is referred to as the heap. The heap includes all of local memory 131 that is not used by code segment 335 or stack 337. Buffers 231-233 are allocated from the memory space within heap 339. The amount of space in heap 339 may vary because, while the size of code segment 335 typically does not change, amount of space used by stack 337 typically does. The total amount of space allocated to buffers 231-233 should be large enough to allow processor 111 to operate efficiently, but small enough to allow room for stack 337 to grow.

As noted above, buffers 231-233 are used as a scratch pad or workspace for temporarily storing data from system memory 150. FIG. 3 illustrates the correspondence between segments of system memory 150 and buffers 231-233 in local memory 131. Buffer 231 corresponds to data segment 351, while buffers 232 and 233 correspond to data segments 352 and 353, respectively. Data is moved from the system memory segments (351-353) to the corresponding buffers (231-233,) where the data can be accessed by the processor. For example, data is moved from system memory segment 351 to buffer 231, where it can be accessed by processor 111. When the data in the buffers is no longer needed by the processor, or when additional space is needed, the data is moved back from the buffers to the appropriate locations in the corresponding system memory segment. In this embodiment, the data is moved via direct memory access (DMA.)

Conventionally, space in local memory 131 is allocated to the different buffers based upon the anticipated needs of the system, and is not changed during operation of the system. At any given time, a particular buffer may be under-utilized or under-sized because the need of the processor for that buffer may not match the needs that were anticipated by the system designer. If the buffer is under-utilized, space in the local memory that is dedicated to the buffer is unused, when it could instead be allocated to a different buffer that needs additional memory space, or left available for storing stack data. If the buffer is under-sized, extra DMA operations will be necessary to move data between the buffer and the corresponding system memory so that the data will be available to the processor. The present system, however, adjusts the sizes of the different buffers (e.g., reducing the size of under-utilized buffers and increasing the size of under-sized buffers) in order to improve the performance of the system.

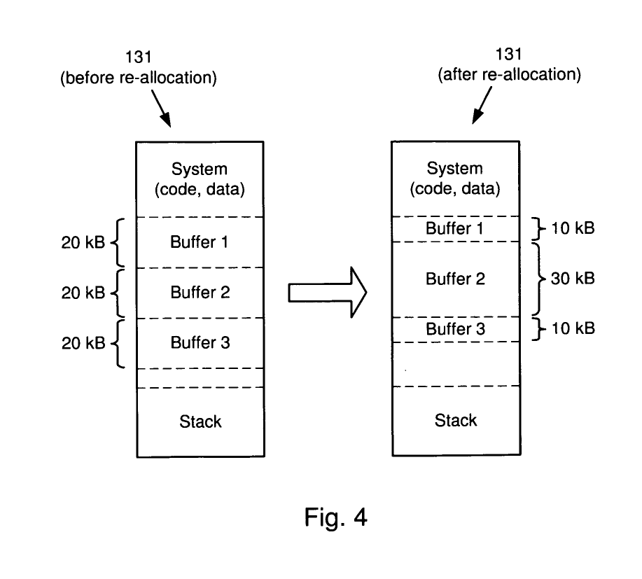

Referring to FIG. 4, a diagram illustrating the re-allocation of local memory space to the buffers associated with different processors in accordance with one embodiment is shown. FIG. 4 includes two blocks showing different allocations of memory space within local memory 131. The block on the left side of the figure corresponds to the allocation of local memory 131 prior to re-allocation, while the block on the right side of the figure corresponds to the allocation of local memory 131 after the memory space has been re-allocated.

In the example of FIG. 4, memory space in local memory 131 is initially allocated to buffers 231-233 in equal amounts. Thus, the left side of the figure shows that 60 kB of memory space is allocated to buffers 231-233, with 20 kB being allocated to each buffer. This allocation is used for a period of time, during which various factors relating to the performance of the system (e.g., the frequency with which data in each buffer is accessed, the number of DMA operations that have been performed, etc.) are monitored. At some point, the performance of the system with respect to the local memory allocation is evaluated. Based upon this evaluation, it may be determined that the amount of memory space allocated to a particular buffer is too much, or too little. This determination serves as the basis for re-allocating memory space for the buffer.

Referring again to the example of FIG. 4, evaluation of the initial local memory allocation (20 kB for each of buffers 231-233) indicates that 20 kB is more space than is needed for buffers 231 and 233. The evaluation further indicates that 20 kB is not sufficient for the needs of buffer 232. The allocation of local memory space among the buffers is then changed in accordance with this evaluation. In particular, the allocation for each of buffers 231 and 233 is reduced from 20 kB to 10 kB, and the allocation for buffer 232 is increased from 20 kB to 30 kB.

As a result of the re-allocation of local memory space, 10 kB of additional memory space is provided in buffer 232. This additional space may make it possible to locally store all of the data currently needed by the processor. If all of the needed data can be stored in buffer 232, the number of DMA operations that would otherwise be required to move data back and forth between buffer 232 and system memory 150 can be reduced. Since 20 kB of memory space was reclaimed from buffers 231 and 233, and since only 10 kB of additional memory space was needed by buffer 232, an additional 10 kB of space can be made available for stack data. By making this additional space available for the stack, it may be possible to avoid stack overflow errors that would otherwise have occurred.

The evaluation of the current usage of the buffer allocations in the local memory may be performed in a variety of ways. In one embodiment, an evaluation function is constructed for use in evaluating the buffer allocations. The evaluation function in this embodiment is based on a first set of factors that are known and a second set of factors that are unknown at the time conventional static allocations are made.

The set of known factors may include such things as the data types that will be used by the processor, the size of the data, specific data types that will be used, etc. These factors may be involved in the conventional determination of static buffer allocations, but they should also be considered in the dynamic evaluation of the buffer allocations. The set of unknown factors may include such things as the frequency with which data in a buffer is actually accessed, the number of DMA operations that are necessary to transfer data to and from a buffer, data access patterns (e.g., small amounts of data accessed frequently, versus larger amounts of data that are infrequently accessed,) etc.

In this embodiment, the evaluation function takes the form

f(x0, x1, . . . , y0, y1, . . . )

where x0, x1, . . . represent known factors, and y0, y1, . . . represent unknown factors. For example, the known factors may include a factor corresponding to the type of data stored in the buffer (x0,) a factor corresponding to a real-time constraint for the processor associated with the buffer (x1,) and a factor corresponding to the size of data stored in the buffer (x2.) The unknown factors may include a factor corresponding to the frequency with which data in the buffer is accessed (y0.) The evaluation function based upon these factors could be as simple as
f(xi,yi)=x0+x1+x2+y0

Alternatively, the different factors could be weighted, resulting in a function of the form
f(xi,yi)=a*x0+b*x1+c*x2+d*y0
where a, b, c and d are weighting factors. Still another alternative form of the evaluation function might be
f(xi,yi)=a*(x0+x1+x2)+b*y0

Clearly, many other variations of the evaluation function are also possible.

In one embodiment, the evaluation function is used to determine the “importance” of each buffer. “Importance” is used here simply to refer to the relative priorities of the different buffers. In other words, one buffer that has greater importance than another buffer should be allocated more memory space than the second buffer. Thus, for each buffer, the evaluation function is computed, and the resulting value indicates the importance of the buffer.

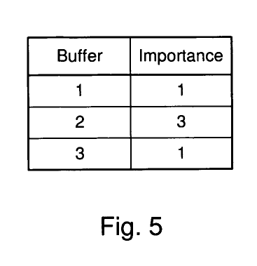

In one embodiment, the importance of each buffer (as determined by the evaluation function) is stored in a table. An exemplary table is depicted in FIG. 5. This table includes a first column that contains an identifier for each buffer, and a second column that contains an importance value corresponding to the identified buffer. The amount of memory space to be allocated to each buffer can then be determined, for example, by multiplying the importance value by some factor. In the example of FIG. 5, buffer 1 has an importance of 1, buffer 2 has an importance of 3, and buffer of 3 has an importance of 1. If the importance of each buffer is multiplied by 10 kB, the result is an allocation of 10 kB for buffer 1, 30 kB for buffer 2, and 10 kB for buffer 3. It can be seen that this corresponds to the buffer sizes shown in FIG. 4 after re-allocation of the local memory space has been performed.

It should be noted that the manner in which the local memory space is allocated based upon the computed importance of each buffer (or other results of the evaluation function) may have many variations. For example, rather than multiplying the computed importance of each offer by a factor (e.g., 10 kB) to arrive at an allocation value, it is possible in alternative embodiments to use the same total amount of memory space for the buffers, but to change the percentages of this space that are allocated to each buffer. In another alternative, there may be predetermined minimum and/or maximum amounts of memory space that can be allocated to each buffer. In yet another alternative, the amount of space allocated to each buffer may be constrained to change by predetermined increments (e.g., 5 kB or 10 kB.) Many other methods for determining the specific amounts of space to the allocated to each buffer will also be apparent to persons of skill in the art of the invention.

Because of the many possible variations in the evaluation of the buffer usage and in the allocation of local memory space based upon this evaluation it may not necessarily be clear whether a particular part of the evaluation/re-allocation methodology falls within the scope of “evaluation” or “reallocation.” It is contemplated that any type of evaluation of the usage of the local memory space and subsequent re-allocation of memory space will fall within the scope of the claimed invention, regardless of the characterization of specific steps as part of the evaluation or the re-allocation of the memory space.

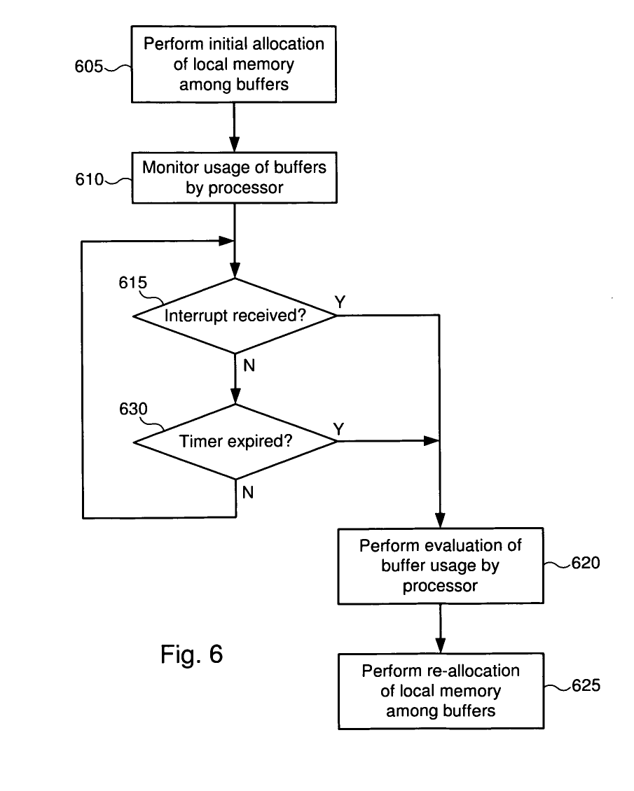

Referring to FIG. 6, a flow diagram illustrating a method in accordance with one embodiment is shown. In this method, the local memory space is initially allocated to the different buffers (block 605.) As noted above, this initial allocation may be performed in accordance with conventional methodologies, such as allocating the same amount of memory space to each of the buffers. After the buffers are initially allocated, the system begins operating. During operation, the system monitors usage of the local memory space allocated to the buffers (block 610.)

In this embodiment, two mechanisms are provided for triggering evaluation and re-allocation of the local memory space. First, the system may receive an interrupt (block 615.) If an interrupt is received, evaluation of the usage of the local memory space is initiated (block 620.) After the memory usage is evaluated, the memory space is re-allocated to the buffers in accordance with the evaluation (block 625.) If no interrupt is received, evaluation of the memory usage may alternatively be triggered by a timer (block 630.) A timer may be set so that, if no interrupts are received within a predetermined interval since the last evaluation, expiration of the timer will trigger the evaluation/re-allocation of the local memory space. In this embodiment, the timer is reset when evaluation of the memory space is initiated, whether the evaluation is triggered by expiration of the timer or receipt of an interrupt.

It should be noted that alternative embodiments may use other mechanisms for triggering evaluation and re-allocation of the local memory space. For instance, it may be possible to trigger these processes and to thereby optimize the buffer allocations in response to a user request. Various other mechanisms may also be implemented.

As noted above, one embodiment is implemented in a multiprocessor system. In this system, the evaluation and re-allocation of the local memory are performed by a local memory manager. The local memory manager implements the evaluation and re-allocation functions in a manner that is transparent to the processors. Consequently, the processors can operate without having to track the changes in the local memory allocations or account for the changing allocations in accessing the data stored in the respective buffers.

The local memory manager may itself be implemented in one of the processors in the system (e.g., the main processor,) or in a separate memory management unit (MMU.) In one embodiment, the evaluation and re-allocation of the local memory is implemented in the MMU so that none of the processing resources of the processors themselves have to be expended on the evaluation/re-allocation functions. The processors are thereby made available to perform other tasks.

In one embodiment, the local memory manager is implemented in software. The software may be executed by one of the processors or by separate MMU hardware. The evaluation and re-allocation functions of the local memory manager may alternatively be provided through the use of specialized hardware components, or by a combination of hardware and software.

In one embodiment, an MMU can virtualize the memory accesses of the processors in the system by controlling the address pointers of the buffers of the different processors. The user programs that are executing on the processors can, for example, read or write data through the use of the function calls that can either immediately access data in the corresponding buffer or load the data from the system memory into the buffer and then access the data from the buffer. An illustrative data structure (data_obj) and function call that may be useful for this purpose in one embodiment are described below.

In this embodiment, a data structure is defined (in C programming code) as follows:

typedef struct data_obj {

unsigned int buf_start;
unsigned int buf_size;
unsigned int buf_min_size;
unsigned int lm_start;
unsigned int current_lm_addr;
unsigned int reference_count;
unsigned int priority;

}

In this data structure, “buf_start” is the starting address of the data in the processor's buffer in the local memory. “buf_size” is the current size of the buffer, and “buf_min_size” is the minimum size of the buffer. “lm_start” is the starting address of the data in the system memory, and “current_lm_addr” is the address (in the system memory) of the data that is currently stored in the buffer. “reference count” is a counter for the number of accesses to the data structure, and “priority” is used to indicate the priority assigned to the buffer.

This data structure can be used by the MMU to control the size and starting address of the buffer within the local memory when it is desired to re-allocate the local memory (through buf_start and buf_size.) The data structure also includes components that are used to store known, static information (priority) and unknown, dynamic information (reference_count) that are used in the evaluation of the buffer's use of the local memory space.

When this data structure is defined, the data used by the processors in the system can be accessed through the following function call:

unsigned int memmgr_load(*data_obj, offset);
/*
* data_obj: data object to be requested
* offset: address to be requested
* return value: actually loaded size of data
*/

This function call allows the processors to access the data within the buffers without having to maintain any awareness of the manner in which the local memory space is allocated to the buffers. As a result, the manipulation of the buffers and their allocation within the local memory does not affect the processors in accessing the data within the buffers. Whenever a processor uses the function call to access data in the corresponding buffer, the data is either accessed directly in the local memory (if the data is already stored in the buffer,) or the data is moved from the system memory to the buffer and is then accessed in the local memory by the processor.

“Computer-readable media,” as used herein, refers to any medium that can store program instructions that can be executed by a computer, and includes floppy disks, hard disk drives, CD-ROMs, DVD-ROMs, RAM, ROM, DASD arrays, magnetic tapes, floppy diskettes, optical storage devices and the like. “Computer”, as used herein, is intended to include any type of data processing system capable reading the computer-readable media and/or performing the functions described herein.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, including wires, metallic traces, vias, optical fibers, and the like.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. Such a storage medium containing program instructions that embody one of the present methods is itself an alternative embodiment of the invention. One exemplary storage medium may be coupled to a processor, such that the processor can read information from, and write information to, the storage medium. In the alternative, the storage medium may be integral to the processor. The processor and the storage medium may reside, for example, in an ASIC. The ASIC may reside in a user terminal. The processor and the storage medium may alternatively reside as discrete components in a user terminal or other device.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A method comprising:
making an initial allocation of local memory space to a plurality of buffers;
performing an evaluation of use of the local memory space by the buffers; and
re-allocating the local memory space to the buffers based upon the evaluation.

2. The method of claim 1, wherein performing an evaluation of use of the local memory space by the buffers comprises providing a function based on use of the local memory space and evaluating the function for the local memory space used by each of the buffers, wherein the function is based upon one or more static factors and one or more dynamic factors.

3. The method of claim 2, wherein one or more of the static factors are selected from the group consisting of: data type; data size; and realtime constraints.

4. The method of claim 2, wherein one or more of the dynamic factors are selected from the group consisting of: frequency of data accesses; and a number of data transfers between the local memory and a system memory.

5. The method of claim 2, wherein evaluating the function results in an importance value, and wherein the local memory space is re-allocated to the buffers based upon the respective importance values for the local memory space used by each of the buffers.

6. The method of claim 5, wherein the local memory space is re-allocated to the buffers in proportion to the respective importance values for the local memory space used by each of the buffers.

7. The method of claim 1, wherein performing the evaluation of use of the local memory space by the buffers and re-allocating the local memory space to the buffers based upon the evaluation is performed in a manner that is transparent to processors that access the buffers.

8. The method of claim 1, wherein performing the evaluation of use of the local memory space by the buffers and re-allocating the local memory space to the buffers based upon the evaluation is performed in response to an interrupt.

9. The method of claim 1, wherein performing the evaluation of use of the local memory space by the buffers and re-allocating the local memory space to the buffers based upon the evaluation is performed in response to expiration of a timer.

10. The method of claim 1, wherein performing the evaluation of use of the local memory space by the buffers and re-allocating the local memory space to the buffers based upon the evaluation is performed by a memory management unit (MMU) that is separate from a processor that accesses the buffers.

11. The method of claim 1, wherein performing the evaluation of use of the local memory space by the buffers and re-allocating the local memory space to the buffers based upon the evaluation is performed by a processor that accesses the buffers.

12. A system comprising:
one or more processors;
a local memory coupled to each of the processors; and
a local memory manager coupled to the local memory;
wherein the local memory manager is configured to periodically evaluate use of buffers in the local memory and to re-allocate the local memory to the buffers based upon the evaluation.

13. The system of claim 12, wherein the local memory manager is configured to evaluate use of the local memory by the buffers by evaluating, for each of the buffers, a function based on use of the local memory space by the buffers, wherein the function is based upon one or more static factors and one or more dynamic factors.

14. The system of claim 13, wherein one or more of the static factors are selected from the group consisting of: data type; data size; and realtime constraints.

15. The system of claim 13, wherein one or more of the dynamic factors are selected from the group consisting of: frequency of data accesses; and a number of data transfers between the local memory and a system memory.

16. The system of claim 13, wherein the local memory manager is configured to evaluate the function for each buffer to generate a corresponding importance value, and to re-allocate the local memory space to the buffers based upon the respective importance values.

17. The system of claim 12, wherein the local memory manager is configured to transfer data between the system memory and the local memory using direct memory access (DMA) operations.

18. The system of claim 12, wherein the local memory manager is configured to evaluate of use of the local memory by the buffers and to re-allocate the local memory to the buffers in a manner that is transparent to the processor.

19. The system of claim 12, wherein the local memory manager is configured to evaluate of use of the local memory by the buffers and to re-allocate the local memory to the buffers in response to an interrupt.

20. The system of claim 12, wherein the local memory manager is configured to evaluate of use of the local memory by the buffers and to re-allocate the local memory to the buffers in response to expiration of a timer.

21. The system of claim 12, wherein the local memory manager is implemented by executing a software program on the processor, wherein the software program is configured to cause the processor to periodically evaluate use of the local memory by the buffers and to re-allocate the local memory to the buffers based upon the evaluation.

22. The system of claim 12, wherein the local memory manager is implemented in a memory management unit (MMU) that is separate from the processor.

23. The system of claim 22, wherein the local memory manager is implemented by executing a software program on MMU hardware, wherein the software program is configured to cause the MMU hardware to periodically evaluate use of the local memory by the buffers and to re-allocate the local memory to the buffers based upon the evaluation.

24. The system of claim 12, wherein the local memory manager is implemented in the processor.

25. The system of claim 24, wherein the local memory manager is implemented by executing a software program on the processor, wherein the software program is configured to cause the processor to periodically evaluate use of the local memory by the buffers and to re-allocate the local memory to the buffers based upon the evaluation.

26. A software program product comprising a computer-readable storage medium that contains one or more instructions configured to cause a computer to perform the method comprising:
making an initial allocation of local memory space to a plurality of buffers;
performing an evaluation of use of the local memory space by the buffers; and
re-allocating the local memory space to the buffers based upon the evaluation.
